(19) United States
(12) Patent Application Publication
(10) Pub. No.: US 2025/0013491 A1
(43) Pub. Date: Jan. 9, 2025

(54) DETERMINING WHETHER A GIVEN TASK IS ALLOCATED TO A GIVEN ONE OF A PLURALITY OF LOGICALLY HOMOGENEOUS PROCESSOR CORES

(71) Applicant: Arm Limited, Cambridge (GB)

(72) Inventors: Shidhartha Das, Upper Cambourne (GB); James Edward Myers, Great Wilbraham (GB); Mark John O'Connor, Luebeck (DE)

(73) Assignee: Arm Limited, Cambridge (GB)

(21) Appl. No.: 18/706,841

(22) PCT Filed: Sep. 28, 2022
(86) PCT No.: PCT/GB2022/052445

§ 371 Date: May 2, 2024

(30) Foreign Application Priority Data
Nov. 9, 2021 (GB) 2116061.9

(51) Int. Cl. G06F 9/48; G06F 11/34

(52) U.S. Cl. CPC G06F 9/485; G06F 9/4893; G06F 11/3409

(57) ABSTRACT

A system on chip (102) comprising a plurality of logically homogeneous processor cores (104), each processor core comprising processing circuitry (210) to execute tasks allocated to that processor core, and task scheduling circuitry (202) configured to allocate tasks to the plurality of processor cores. The task scheduling circuitry is configured, for a given task to be allocated, to determine, based on at least one physical circuit implementation property associated with a given processor core, whether the given task is allocated to the given processor core.

The present technique relates to the field of data processing.

In a system on chip (SoC), multiple processor cores (e.g. central processing units-CPUs) may be provided, and tasks (e.g. processes) may be distributed between the processor cores. The number of processor cores which may be provided on a single chip (SoC) may depend on various factors; however, due to ever-increasing demand for better performance, the number of processor cores on a single SoC has tended to increase over time. Indeed, in some cases the number of processor cores on a single chip can reach 100, with even further increases possible in future. Therefore, the scheduling of tasks on a SoC is becoming increasingly difficult.

Viewed from a first example of the present technique, there is provided a system on chip comprising:
a plurality of logically homogeneous processor cores, each processor core comprising processing circuitry to execute tasks allocated to that processor core; and
task scheduling circuitry configured to allocate tasks to the plurality of processor cores,
wherein the task scheduling circuitry is configured, for a given task to be allocated, to determine, based on at least one physical circuit implementation property associated with a given processor core, whether the given task is allocated to the given processor core.

Viewed from another example of the present technique, there is provided a method of allocating tasks to a plurality of processor cores, the plurality of processor cores comprising a plurality of logically homogeneous processor cores within a system on chip, each processor core comprising processing circuitry to execute tasks allocated to that processor core, and the method comprising, for a given task:
obtaining at least one physical circuit implementation property associated with a given processor core; and
selecting, based on the at least one physical circuit implementation property, whether the given task is allocated to the given processor core.

Viewed from another example of the present technique, there is provided a computer program for controlling a computer to perform the above method.

Further aspects, features and advantages of the present technique will be apparent from the following description of examples, which is to be read in conjunction with the accompanying drawings, in which:

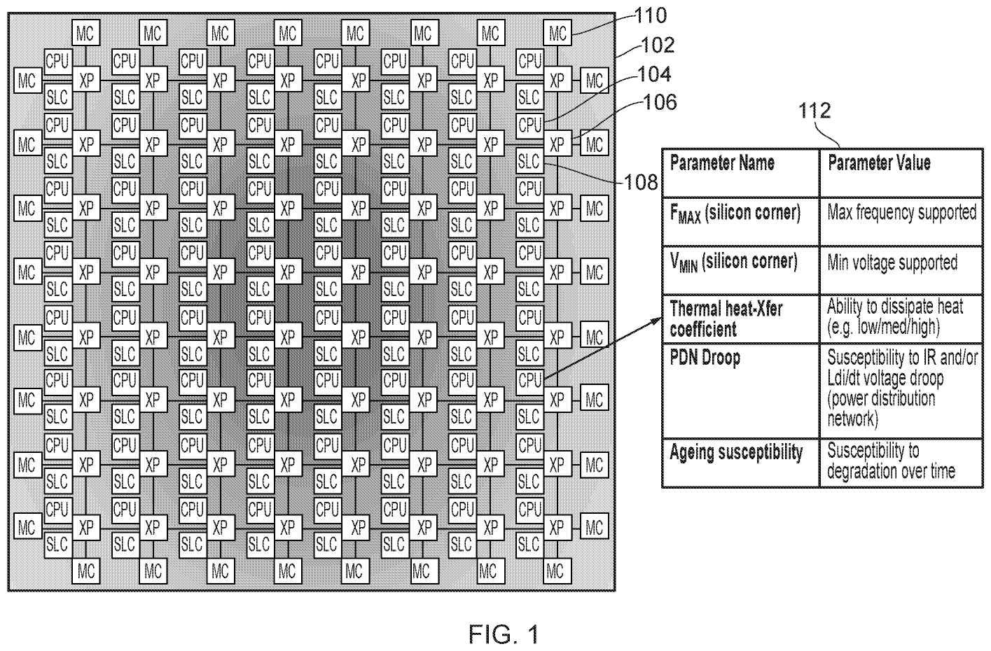

FIG. 1 schematically illustrates an example of a system on chip (SoC);

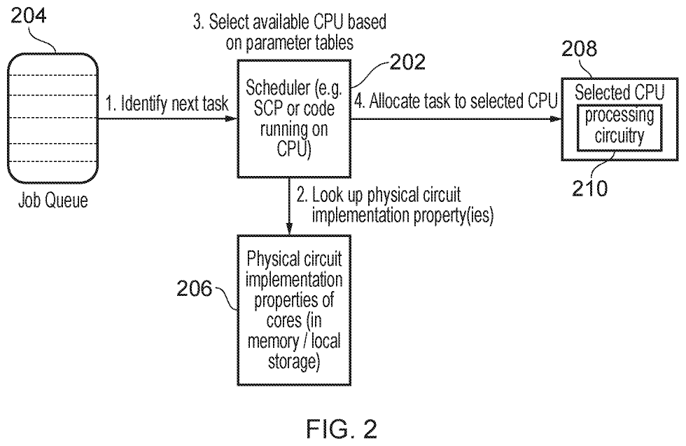

FIG. 2 schematically illustrates task scheduling circuitry for determining whether to allocate a task to a selected processor core (CPU);

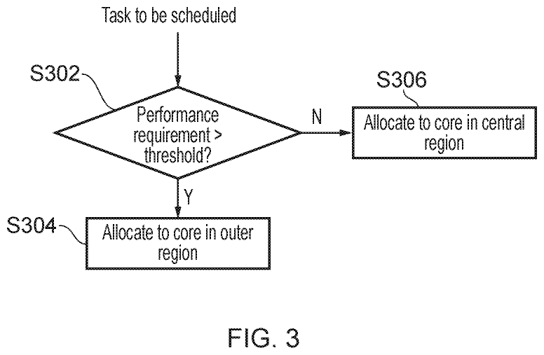

FIG. 3 is a flow diagram illustrating a method of scheduling a task for execution by a selected processor core;

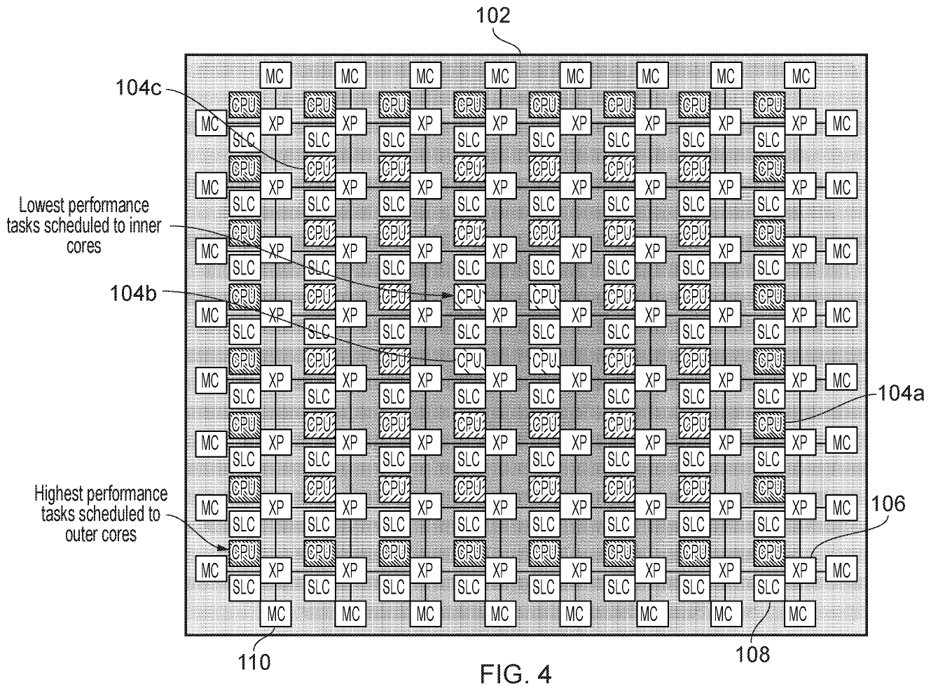

FIG. 4 schematically illustrates the heat distribution on a SoC after applying a method such as that in FIG. 3; and

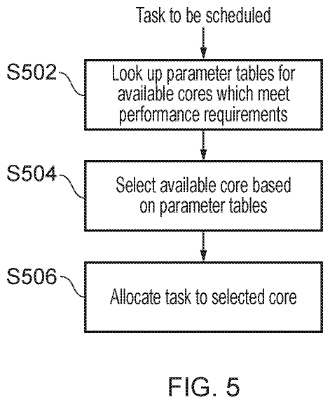

FIGS. 5 to 7 are flow diagrams illustrating methods of scheduling a task for execution by a selected processor core.

Before discussing example implementations with reference to the accompanying figures, the following description of example implementations and associated advantages is provided.

In accordance with the present technique there is provided a system on chip (SoC; also referred to as a chip) comprising a plurality (e.g. two or more) of logically homogeneous processor cores—e.g. a plurality of processor cores (also referred to as cores, processors or CPUs) all supporting the same instruction set architecture so as to be capable of executing the same workloads, and having the same design in terms of their micro-architectural arrangement and/or logical arrangement of transistors. Each processor core in the plurality of logically homogeneous processor cores comprises processing circuitry to execute tasks (e.g. processes) allocated to that processor core. It will be appreciated that there may, optionally, be one or more further processor cores provided (e.g. in addition to the plurality of logically homogeneous processor cores), which do not necessarily have the same design as the plurality of logically homogeneous cores.

Task scheduling circuitry is also provided, and is configured to allocate (e.g. schedule) tasks to be executed by the plurality of logically homogeneous processor cores.

Scheduling decisions in a many-core SoC—e.g. decisions as to which tasks are to be executed by which processor cores—may be based on any of a number of factors. For example, the availability of each core may be taken into account when deciding where to schedule a given task, in which the availability of a given core may depend on whether it is already executing a task. The availability of a given core could also depend on whether it is currently powered down (e.g. power-off) or in a low-power state; for example, when a given core overheats (e.g. due to heat produced by the given core or surrounding cores as a by-product of executing tasks), or is close to overheating, it may be put into a low-power or power-off state to allow it to cool down.

However, the inventors of the present technique realised that, even in a SoC where all of the processor cores are logically homogeneous, there may be slight differences in the physical circuit implementation properties of the cores. For example, there may be slight differences due to the physical arrangement of the cores on the SoC, or minor “silicon corner” differences introduced during fabrication of the cores due to local variation in conditions such as temperature, pressure, etc. for different parts of the SoC during the manufacturing process. Moreover, the inventors realised that these differences can have an effect on the suitability of a given processor core to execution of a given task. For example, the inventors realised that better performance and/or reduced energy consumption may be possible if a given task is allocated to a particular one of the logically homogeneous cores, even though from a functional point of view any of those cores may be capable of executing the task as they may have the appropriate logical circuit components for carrying out the required functionality.

In consideration of this issue, the task scheduling circuitry (also referred to as a scheduler, task scheduler or scheduling circuitry) of the present technique is configured, for a given task to be allocated, to determine, based on at least one physical circuit implementation property associated with a given processor core, whether the given task is allocated to the given processor core.

By taking into account the at least one physical circuit implementation property associated with the given processor core (e.g. a physical property of the given processor core or of the circuitry/arrangement of the SoC) when determining whether the given task is allocated to that core, the present technique allows for improvements in terms of performance and/or energy consumption to be achieved, depending on the particular requirements and priorities of a given implementation.

Taking into account such physical circuit implementation properties might seem counter-intuitive, since one might expect all of the processor cores to behave the same, given that they are logically homogeneous. One might also assume that any improvement in performance and/or reduction in energy consumption achieved by applying this technique would be fairly insignificant. However, the inventors realised that this is not necessarily the case. As the number of processor cores on a typical SoC increases—for example, sometimes there may be upwards of 100 processor cores on a single SoC, which may be arranged in a two-dimensional or even a three-dimensional array—there is potential for significant improvements in terms of both performance and energy efficiency. Moreover, as the demand for better performance and lower energy consumption increases, even small improvements can become significant.

Hence, by taking into account the physical circuit implementation properties of a core when deciding whether or not to allocate a task to it—rather than, for example, merely considering whether or not the core is available—can, unexpectedly, provide significant advantages.

The physical circuit implementation property or properties considered by the task scheduling circuitry may include any physical property of the given processor core itself and/or a property of its local environment on the SoC. However, in some examples, the at least one physical circuit implementation property comprises at least one of an ability to dissipate heat away from the given processor core, and a duration that a given performance level can be maintained on the given processor core.

For example, the ability to dissipate heat away from the given processor core may indicate the rate at which the core itself can expel/dissipate heat (e.g. it could be a property of the processor core itself, dependent on how much heat is generated by the core when executing a task, and how good the core is at expelling that generated heat), and/or it may indicate the ability of the SoC as a whole to dissipate heat away from that processor core (e.g. it could be a property of the local environment of the given processor core on the SoC, e.g. based on the relative position of the core relative to other cores or to the boundaries of the SoC). Similarly, the duration that a given performance level can be maintained on the given processor core (e.g. this could be time limit indicative of the amount of time that it is expected that the processor core could operate at the given performance level) could also be a property of either the processor core itself or of its environment. For example, this could be an indication of the performance capabilities of the core itself, or it could be based on how long a core can maintain a given performance level before overheating.

Making scheduling decisions based on either (or both) of these properties can lead to an improvement in the performance of the SoC as a whole. For example, by considering the ability to dissipate heat away from the processor core, it is possible to schedule tasks so as to reduce the likelihood of one of the processor cores overheating and needing to be powered down. This allows more of the processor cores to remain in operation for a longer duration, thus allowing a higher performance level to be maintained for a longer duration. Scheduling tasks based on the ability to maintain a given performance level on the given processor core for a predetermined time can also lead to an overall improvement in performance, since this allows tasks which require higher performance to be allocated to processor cores capable of operating at this higher performance level for the duration of the task.

In some examples, the at least one physical circuit implementation property comprises at least one of the following:
a position of the given processor core within the system on chip;
a thermal heat transfer parameter associated with the given processor core;
an upper limit of frequency at which the given processor core can operate;
a lower limit of voltage at which the given processor core can operate;
a susceptibility of the given processor core to voltage drops; and
a susceptibility of the given processor core to aging.

The at least one physical circuit implementation property could be any one of these options, or multiple properties could be considered in combination. The position of the given processor core within the SoC (chip) can be characterised in terms of its position relative to other the processor cores on the chip and/or its position relative to the chip itself. For example, the position of the given processor core can include one or both of:
an indication of the concentration of processor cores in an area surrounding the given processor core (e.g. this could be an indication of the distance of the given processor core from the nearest chip boundary (edge of the chip), since the concentration of processor cores towards the centre of the chip will typically be greater than the concentration of processor cores at the chip boundary). The concentration of processor cores in a given area of the chip can affect not only the amount of heat generated in the area surrounding the given processor core (e.g. more processor cores in a given area can mean more heat is generated), but also the heat conductivity of the area surrounding the given processor core, thus affecting how quickly heat can be dissipated away); and
an indication of how exposed the processor core is to the external environment outside of the chip—this can affect the rate at which heat is dissipated away from the given processor core. Again, this could be based on the distance between the given processor core and the nearest chip boundary, since processor cores closest to the chip boundary may be more exposed to the external environment, and thus heat may be dissipated away from these cores more easily. For example, in a two-dimensional array of processor cores, this could be a measure of the distance between the given processor core and at least one edge of the chip. Alternatively, in a three-dimensional array of processor cores (e.g. in a 3D integrated circuit), this could depend on whether the given processor core is in a top or bottom layer of the 3D stack, or on an intermediate layer—e.g. intermediate layers may be less good at dissipating heat.

The thermal heat transfer parameter associated with the given processor core is another example of an ability to dissipate heat away from the given processor core, and could—for example—be represented as a numerical value characterising this ability, or it could simply be a classification of the given processor core's ability to dissipate heat away as, for example, high, medium or low. It will be appreciated that this is just one example of how the thermal heat transfer parameter of the given processor core can be classified—in other examples, there may be fewer than three (e.g. two—high and low) or more than three categories.

The upper limit of frequency (e.g. number of clock cycles per second—F_{MAX}) at which a given processor core can operate may be indicative of how quickly the processor can execute a task, and hence can indicate the ability of the processor to operate at a higher performance level. In this way, by considering the F_{MAX} value of the given processor core, it is possible to conserve the cores that support higher frequencies (e.g. the cores with higher values of F_{MAX}) for the tasks that will benefit from using them (e.g. tasks with higher performance requirements), rather than wasting performance resources by scheduling a low performance task on a processor core that could support a higher F_{MAX}.

The lower limit of voltage (V_{MIN}) at which the given processor core can operate can indicate a lower limit for the energy consumption of the given core—for example, a core which can operate at a lower voltage can be configured to consume less power by decreasing the frequency at which it operates, while cores which have a V_{MIN} may not benefit as much from lower operating frequency because even if the frequency is reduced the voltage may be pinned at the higher V_{MIN} to detract from the power savings achieved by reducing the frequency. Scheduling tasks based on the lower limit of voltage at which the given processor core can operate (e.g. scheduling tasks with lower performance requirement on cores with lower V_{MIN}) can, therefore, help to manage the energy consumption of the SoC overall.

The susceptibility of the given processor core to aging could be an example of either or both an ability to execute at a given performance level and an ability to dissipate heat away—or example, areas of the core or the chip which are subject to more prolonged heating may suffer increased aging effects (such as negative-bias temperature instability-NBTI) which may also cause a slowdown in performance. Hence, once the age of the SoC exceeds a given time duration, when scheduling tasks with a higher performance requirement, a core with lower susceptibility to aging could be selected in preference to a core with higher susceptibility to aging, for example.

Accordingly, considering one or more of the above physical circuit implementation properties associated with the given processor core can allow the performance and/or energy efficiency of the SoC to be improved.

In some examples, the task scheduling circuitry is configured to determine whether the given task is allocated to the given processor core in dependence on at least one performance requirement associated with the given task.

In this way, the task scheduling circuitry can balance the performance requirements of the given task with the at least one physical circuit implementation property associated with the given core. This allows for an improvement in performance.

In some examples, the at least one physical circuit implementation property comprises a position of the given processor within the system on chip, and when the at least one performance requirement exceeds a threshold performance requirement, the task scheduling circuitry is configured to allocate the given task to a processor core in an outer region of the system on chip.

In a many-core SoC, the processor cores towards the centre of the chip (e.g. in a central region) may be more susceptible to overheating than processor cores towards the edge (e.g. in an outer region) of the chip. For example, this could be due to the larger concentration of processor cores in the centre of the SoC, leading to the generation of more heat in the central region than in outside regions. Another reason that the processor cores in the central region of the chip may be more susceptible to overheating is that they are less exposed to the outside environment—processor cores at the very edge of the chip are exposed to the outside environment (e.g. the air) on more sides than the processor cores towards the centre of the chip, which can make it easier to dissipate heat away from these cores. This effect is apparent in both two-dimensional and three-dimensional SoCs, but the effect may be even stronger in a three-dimensional SoC, where any heat generated by the processor cores towards the middle of the SoC (e.g. processor cores in intermediate layers of the 3D stack making up the 3D integrated circuit—e.g. the “inner region” for a 3D stack could include the intermediate (e.g. not the top or the bottom) layers, while the “outer region” could include the top and bottom layers) might need to travel through the rest of the chip to reach the external environment, thus making it even more difficult for the heat to be dissipated.

Hence, the present technique may involve scheduling high-performance tasks to processor cores in an outside region of the SoC. This can provide significant improvements in terms of improved performance. For example, this approach allows the processor cores towards the centre of the chip to operate at a lower power (e.g. at a lower performance level), so that they generate less heat. This reduces the likelihood of the cores at the centre of the chip overheating, and needing to be powered-down, which allows a higher performance level to be maintained on the SoC for a longer duration (e.g. because more cores remain in operation for longer).

A central region of the chip is a region towards the centre of the SoC, and includes at least the one or more processor cores that are closer than any of the other processor cores to the centre of the SoC (e.g. the one or more processor cores which are furthest from at least on chip boundary (e.g. an edge of the chip or, in a 3D integrated circuit, the top or bottom layers)). For example, this region could encompass all of the cores that are closer to the centre of the SoC than to the edge of the SoC, or it could contain only a given number of processor cores that are closer to the centre than any other processor core on the SoC. An outer region of the chip is a region towards the edge of the SoC, and includes at least a subset of the processor cores which are, in at least one direction, furthest away from the centre of the chip (e.g. at least a subset of the processor cores which are closest to at least one chip boundary). For example, this region could encompass all of the cores that are closer to the edge of the SoC than to the centre of the SoC, or it could include only the processor cores which are furthest away from the centre of the chip. The outer region could, alternatively, be defined relative to the central region—e.g. the outer region could encompass all of the processor cores which are not in the central region. Moreover, it should be appreciated that there may be more than two regions on the SoC. Further, it should be appreciated that the regions of the chip need not, necessarily, be marked on the chip, and the definitions of the regions may not be used for any purpose other than scheduling of tasks.

In some examples, the at least one physical circuit implementation property comprises the lower limit of voltage at which the given processor core can operate, and when the at least one performance requirement is less than a threshold performance requirement, the task scheduling circuitry is configured to allocate the given task to a processor core with a lower limit of voltage below a predetermined value.

As noted above, the lower limit of voltage at which the given processor core can operate (V_{MIN}) can indicate a lower limit for the energy consumption of the given core under Dynamic Voltage and Frequency Scaling (DVFS); for example, cores with a lower V_{MIN} can operate at a lower performance level (e.g. at a lower frequency), thus consuming less energy per operation. Accordingly, V_{MIN} can effectively cap the amount by which the energy consumption of a given core can be reduced via DVFS.

By allocating low-performance tasks (e.g. low-priority tasks) to processors with a lower V_{MIN}, it is possible to reduce the overall energy consumption of the SoC. For example, if one were instead to schedule low-performance tasks—e.g. tasks for which it is acceptable to reduce the performance (and hence the power consumption) of the allocated core, for example by lowering the frequency at which the core operates—to processor cores with a higher V_{MIN}, the potential energy savings may be capped based on V_{MIN} (e.g. since the voltage of these cores could only be reduced to V_{MIN}, capping the amount by which energy consumption can be reduced under DVFS). On the other hand, if tasks with lower performance requirements are scheduled to processor cores with lower V_{MIN}, the performance of these cores (e.g. the frequency) and their operating voltages can be reduced further, thus allowing for reduced energy consumption. Moreover, by reducing the performance of these cores, the amount of heat generated by these cores can also be reduced, thus reducing the likelihood of these cores (or neighbouring cores) overheating and needing to be powered down or put in a low-power state. Hence, scheduling lower-performance tasks to cores with lower values of V_{MIN} can also help to improve the performance of the system (because more of the processor cores remain operational for a longer period of time).

In some examples, the at least one physical circuit implementation property comprises a position, relative to a power distribution network of the system on chip, of the given processor core within the system on chip.

In a SoC, a power distribution network may be provided to provide power to each processor core. For example, the power distribution network could comprise a network of power rails overlaying the processor cores, with each processor core being provided with an connection to a pair of power rails. Within the SoC, there may be slight variations in performance, energy consumption and ability to dissipate heat at various positions relative to the power distribution network. For example, it may be more difficult to dissipate heat away from a core positioned close to a component of the power distribution network that generates a lot of heat. There may also be slight variations in performance due to variations in the power supply at different positions within the power distribution network. Therefore, improvements in performance can be achieved by considering, as the at least one physical circuit implementation property, the position of the given processor core relative to the power distribution network.

In some examples, the at least one physical circuit implementation property comprises an upper limit of frequency at which the given processor core can operate, the given task is associated with a given frequency indicative of a performance requirement of the given task, and the task scheduling circuitry is configured to determine whether the given task is allocated to the given processor core in dependence on the given frequency.

As mentioned above, it can be useful to consider a performance requirement of the given task when determining whether to allocate it to the given processor core. The given frequency (FREQ) of the task is one example of a performance requirement, and may indicate a frequency (or a lower limit of frequency) at which a processor core is required to operate when executing this task. Therefore, considering (e.g. comparing) the given frequency associated with the task and the upper limit of frequency (F_{MAX}) at which the given processor core can operate provides a way of determining whether the given core can adequately (e.g. at the required/desired performance level) execute the given task.

In some examples, the task scheduling circuitry is configured to allocate the given task to a processor core for which the upper limit of frequency is equal to or greater than the given frequency.

This can enable the given task to be executed at the required performance level, thus allowing the performance of the system to be improved overall.

In some examples, the at least one physical circuit implementation property comprises a susceptibility of the given processor core to voltage droops, and the task scheduling circuitry is configured to determine whether the given task is allocated to the given processor core in dependence on a droop characteristic associated with the given task.

When processing a workload, the voltage across a processor core can drop relative to the nominal supply voltage, due to the presence of various resistive, inductive and/or capacitive components in the processor core. For example, a change in demand (e.g. when the chip first starts/stops executing a task) may trigger a temporary drop in voltage followed by a spike in voltage. Voltage drops are also possible during steady state operation. Such voltage drops (also known as voltage droop) can cause instability in the processor core, for example if it reduces the voltage across the core to below the voltage required to operate at the required frequency for the task. For example, even if the supply voltage is nominally high enough, if there is a large resistance across the chip (e.g. if there are a large number of processor cores in operation on the chip) and a high performance demand, then the effective voltage seen by some parts of the chip may drop too low. Different processor cores may have different susceptibility to voltage droop, e.g. due to variation in the relative position of the core relative to a power delivery network. Therefore, it can be beneficial—e.g. in terms of performance—to take into account the susceptibility of both the given processor core and the given task, when deciding which processor core to allocate the given task to.

In some examples, the susceptibility of each processor core to voltage droops comprises an indication of whether each processor core is more susceptible to a resistive voltage droop or a reactive voltage droop, and the droop characteristic of the given task is indicative of whether the given task is more susceptible to the resistive voltage droop or the reactive voltage droop.

There may be a number of causes of a voltage droop in a processor core, and some processor cores may be more susceptible to some types of voltage droops than others. For example, the voltage droop could have a resistive component, proportional to the electrical resistance within the circuit—e.g. the electrical resistance provided by the components within the processor core. Resistive voltage droop may be more prevalent when carrying out a sustained workload at relatively high performance. The voltage droop could also (either alternatively or in addition) have a reactive (e.g. inductive) component. For example, there may be an inductive component related to, for example, opposition to the flow of current caused by an inductance, with the inductive voltage droop occurring due to changes in the flow of current (e.g. due to changes in the performance demand)—e.g. an inductance could be created within the power delivery network, reducing the voltage supplied to the given processor core. An inductive component to the voltage droop may be proportional to the rate of change of the current (di/dt) and the inductance (L). A reactive voltage droop may also be affected by capacitors within the circuit. A particular processor core may be more susceptible to one type of voltage droop than others. For example, in some areas of the SoC the effect of reactance within the power delivery network may be larger than in other areas, and so the reactive component of the impedance may be more significant; alternatively, in other areas of the SoC, the resistive component may be more significant. For example, the susceptibility to voltage droop of each type may vary depending on the relative position of the core relative to a power delivery network, and on the silicon corner effects arising in the manufacture of the logical circuit components of the core. Similarly, a given task may be more susceptible to one type of voltage droop than others, and so a droop characteristic of the given task may indicate which type of voltage droop it is more susceptible to. It should be noted that the indications of whether the given processor core or the given task is more susceptible to a resistive or a reactive voltage droop can be specified in any way; for example, the indication could be a single parameter identifying either resistive or reactive voltage droop (e.g. a comparative indication of which is dominant). Alternatively, the indication could comprise two separate parameters, one characterising the resistive droop susceptibility and the other characterising the reactive droop susceptibility; indeed, there could even be three separate parameters-one for each of the resistive, inductive and capacitive components. In either case, improved performance can be achieved by taking into account which form of voltage droop each of the given processor core and the given task are more susceptible to when determining where to allocate the given task.

In some examples, when the droop characteristic of the given task indicates that the given task is more susceptible to the resistive voltage droop, the task scheduling circuitry is configured to allocate the given task to a processor core which is less susceptible to the resistive voltage droop. On the other hand, in these examples, when the droop characteristic of the given task indicates that the given task is more susceptible to the reactive voltage droop, the task scheduling circuitry is configured to allocate the given task to a processor core which is less susceptible to the reactive voltage droop.

In this way, the effect of voltage droops can be reduced, allowing the performance of the SoC as a whole to be improved by allowing a greater amount of processing workload to be performed without risk of brownouts caused by the voltage dropping below the limit of safe operation.

In some examples, when the droop characteristic of the given task is unknown, the task scheduling circuitry is configured to perform on-chip profiling of the given task to determine an estimate of the droop characteristic.

The droop characteristic of a given task may not initially be known by the task scheduling circuitry, and so it can be helpful to perform on-chip profiling to determine a droop characteristic for the task. The on-chip profiling may involve techniques such as machine learning or the application of simple regression models. Such techniques may, for example, starting from an initial estimate of the droop characteristic and refine the estimate based on the results of execution of the task, so that each time the task is encountered by the task scheduling circuitry, the estimate of the droop characteristic is improved.

In some examples, in at least one mode, the given task comprises a task already being executed by the given processor core, the task scheduling circuitry is configured to determine, based on the at least one physical circuit implementation property, whether a different processor core is a better choice for the given task than the given processor core, and the task scheduling circuitry is responsive to determining that the different processor core for is a better choice for the given task to re-allocate the given task from the given processor core to the different processor core.

While one use for the present technique could be in scheduling tasks before they are executed—e.g. as they reach the top of a job queue buffering job identifiers for each pending task-another use for the present technique could be in re-scheduling a task which is already being executed by one of the processor cores. For example, if another processor core becomes available which is more suitable or a better choice for the given task—e.g. if, based on the at least one physical circuit implementation property, the task scheduling circuitry determines that (1) one of the other processor core would be a better choice in terms of, e.g., performance and/or (2) the given processor core will soon (e.g. within a predetermined period) reach its time limit for which a given performance level can be maintained before the core overheats—then the task scheduling circuitry may re-allocate the task to that processor core. The task scheduling circuitry of the present technique may, therefore, be configured either for the initial scheduling of tasks or the re-scheduling of tasks that have already been allocated. Alternatively, the task scheduling circuitry could be configured to perform both the initial scheduling and re-scheduling, possibly as separate modes of operation.

In some examples, the at least one physical implementation property comprises a thermal property associated with the given core.

For example, when the task scheduling circuitry is configured to re-schedule tasks which have already been allocated, this could be to give a prediction of how long the task can remain on the current core before exceeding temperature limits.

In some examples, the task scheduling circuitry is configured to select, as the given processor core, an available processor core which meets at least one performance requirement associated with the given task.

Some processor cores—e.g. those which are currently executing tasks—may not be available to execute the given task. It can, therefore, be helpful to exclude these unavailable processor cores when selecting the given processor core. It can also be helpful to exclude any processor cores which do not meet at least one performance requirement associated with the given task, since these processor cores may not be capable of maintaining the required level of performance for the task. Hence, in this example, these factors are taken into account when selecting a processor core to be the given processor core.

In some examples, each of the plurality of logically homogeneous processor cores has at least one of: the same microarchitectural arrangement, and the same logical transistor arrangement.

In a SoC comprising plurality of homogeneous processor cores, such as the SoC of the present technique, the microarchitectural arrangement of each logically homogeneous processor core—e.g. the way in which the ISA is implemented within each processor core, for example in terms of the specific arrangement of components (such as caches, pipeline stages, prediction mechanisms etc.) within the processor core—may be the same. Similarly, it will be appreciated that each of the processor cores may have the same logical transistor arrangement (e.g. the functional inter-relationships between transistors, in terms of how their inputs and outputs are connected together, may be the same). In either case, one might expect that the behaviour of each processor core in response to a particular task would be identical to the behaviour of each other processor core in executing the same task, and thus it might be counter-intuitive to consider properties associated with individual processor cores when scheduling tasks. However, the inventors realised that even when the microarchitectural arrangement of multiple processor cores is the same, there can still be slight variations between the cores that are introduced during fabrication, or due to the local environment or position of each core within the SoC. Therefore, the present technique can be beneficial even when the micro-architecture and/or logical transistor arrangement of the processor cores is identical.

In some examples, the task scheduling circuitry comprises one of a dedicated task scheduling processor core, and one of the plurality of logically homogeneous processor cores executing a task scheduling process.

Thus, in some examples, the task scheduling circuitry can either be implemented as a dedicated piece of hardware (e.g. a system control processor (SCP) on the SoC), or as software executing on one of the cores.

Particular embodiments will now be described with reference to the figures.

FIG. 1 schematically illustrates a system on chip (SoC) 102, comprising a plurality of logically homogeneous processor cores 104 (CPUs in this example), each core comprising processing circuitry (not shown in FIG. 1) to execute tasks (e.g. processes/workloads) allocated to that core. The processor cores 104 in FIG. 1 are, therefore, an example of a plurality of logically homogeneous processor cores, each processor core comprising processing circuitry to execute tasks allocated to that processor core. The processor cores 104 are, in this example, arranged in a two-dimensional array and each processor core 104 is connected to the rest of the array via a crosspoint (XP) 106. In the example of FIG. 1, a system-level cache (SLC) 108 is also connected to and accessible via each crosspoint 106. Each system level cache is configured to store copies of a subset of data stored in off-chip memory (not shown), to allow the processor cores 104 to access this data with reduced latency.

The SoC of FIG. 1 also includes a number of memory controllers (MC) 110. These are connected to the crosspoints 106 around the edge of the SoC, and provide a connection between the processor cores 104 on the chip 102 and off-chip memory.

It will be appreciated that the number of processor cores 104 provided on the SoC 102 is not particularly limited, and the plurality of processor cores may comprise any number (greater than one) of processor cores. Moreover, the arrangement of the processor cores is not limited to a two-dimensional array as shown in FIG. 1, and any other arrangement of the plurality of processor cores can be used. For example, a three-dimensional array of processor cores could be provided instead.

Each of the processor cores 104 is arranged to execute tasks (e.g. programs/instructions), and task scheduling circuitry is arranged to determine which tasks should be allocated to which cores. For example, the task scheduling circuitry may schedule tasks in dependence on the availability of each processor core. The task scheduling circuitry may either be one of the plurality of processor cores 104 executing a task scheduling program, or separate hardware (e.g. a system control processor, SCP). When the task scheduling circuitry is provided as separate hardware (e.g. separate from the plurality of processor cores 104), it may be provided as dedicated task scheduling hardware, or it may be provided by another piece of hardware that also has other functions.

In the example of FIG. 1, all of the processor cores 104 on the SoC 102 are logically homogeneous, meaning that the design of each core (e.g. in terms of the microarchitectural arrangement and/or the logical transistor arrangement within each core) is identical to that of every other core. In particular, the processor cores 104 are logically homogeneous in the sense that they not only have the same instruction set architecture (ISA), but also the same micro-architectural details. For example, each of the processor cores may have the same design, from a functional point of view, of micro-architectural components such as:
the specific arrangement of pipeline stages (e.g. fetch, decode, rename, issue, execute, etc.),
the particular execute units provided (e.g. how many ALUs are provided in parallel, whether a vector processing unit is provided, etc.),
the particular implementation of cache structures such as data caches, instruction caches or translation look-aside buffers (TLBs) (e.g. micro-architectural properties such as the number of cache levels, size/associativity of each cache level, etc. could be the same for each core),
the implementation of prediction mechanisms like branch predictors and/or prefetchers, etc.

However, even though each of the processor cores 104 has the same design, there can still be physical circuit implementation variations between them that can affect the performance capabilities and ability to dissipate heat away from each of the processor cores. For example, minor variations may be introduced during fabrication of each processor core, known as “silicon corner” variations; these variations may affect, for example, the upper limit of frequency (F_{MAX}) or the lower limit of voltage (V_{MIN}) at which a given processor core can operate.

These variations may also be related to the position of each core on the chip. For example, the position of each processor core relative to the power delivery network (PDN)—e.g. the network of power rails overlaying the processor cores, which deliver power to the processor cores—can affect its susceptibility to voltage droops (e.g. whether the core is more susceptible to resistance-based voltage droops or reactance-based voltage droops), its performance (e.g. cores further from a power delivery node in the PDN might be less capable of operating at higher performance levels than cores that are closer to a power delivery node, due to the additional resistance provided by the longer wires connecting the further cores to the power delivery node), and its susceptibility to aging (e.g. degradation of performance and other properties over time—however, this can also be affected by silicon corner variations). The position of each core on the chip can also affect the ability to dissipate heat away from that core. For example, more heat may be generated towards the centre of the chip than towards the outside of the chip, due to the greater concentration of processor cores in the centre. In addition, the processor cores towards the centre of the chip are less exposed to the air (or the external environment in general), making it more difficult to dissipate heat away from these cores. Accordingly, the thermal heat transfer properties of the processor cores towards the centre of the chip may be different to the thermal heat transfer properties of those cores at the edges of the chip. As can be seen from the Figure, this can cause there to be a noticeable temperature gradient between the centre of the chip, where the temperature is highest, and the edge of the chip. As a result, the processor cores towards the centre of the chip may be more prone to overheating.

Table 112 illustrates some parameters indicative of the variations between the processor cores 104 discussed above. In particular, the table illustrates the following parameters, however it should be noted that these are merely examples, and other parameters could be defined instead/as well:
F_{MAX}: an upper limit of the frequency (e.g. number of clock cycles per second) at which a given processor core can operate. This is indicative of how quickly the processor can execute a task, and hence indicates the ability of the processor to operate at a higher performance level.
V_{MIN}: a lower limit of the voltage at which the processor can operate. This is indicative of the extent to which power can be saved by reducing operating voltage.
Thermal heat transfer (heat-Xfer) coefficient: an indication of how easily and/or quickly heat can be dissipated away from the given processor core. This could be a numerical value, or it could be a category (e.g. high, medium or low). In other examples, the thermal heat transfer coefficient could be represented in terms of the position of a processor core on the chip—for example, the heat transfer coefficient of a given core could indicate that it is in an outer, intermediate or inner position on the chip. Processor cores with a good (e.g. high) thermal heat transfer coefficient may be more suitable for executing higher-performance tasks which generate a larger amount of heat, since they might be less prone to overheating than those with lower thermal heat transfer coefficients.
PDN Droop: an indication of the susceptibility of the given processor core to voltage droops associated with the power delivery network (PDN). For example, this could indicate whether the processor is more susceptible to resistive (IR) voltage droops or inductive (Ldi/dt) voltage droops. The droop susceptibility of a given processor indicates its stability, and thus gives an indication of the ability of the processor to sustain a given performance rate over time.
Aging susceptibility: an indication of the susceptibility of the processor core and/or surrounding components to degradation over time. For example, the performance of a processor core may degrade if its components or the surrounding circuitry degrade, and so this could be an indication of the performance capabilities of the processor at a given point of the lifetime of the SoC.

The above parameters are all examples of physical circuit implementation properties associated with a given processor core, and some or all of these parameters may be stored, for each processor core 104, in storage circuitry accessible to the task scheduling circuitry. For example, a parameter table similar to the table 112 shown in FIG. 1 (although it will be appreciated that the table may identify a different set of parameters than those shown in the figure) may be stored for each processor core; alternatively, there may only be a single parameter stored for each core. In other examples, there may not be a parameter stored for every core: for example, there may only be parameters stored for a subset, but not all, of the processor cores. The parameters could, in examples such as these, initially be obtained by testing to characterise the properties of the cores, the testing being performed during the manufacturing phase. In another example, there may (at least initially) not be any parameters stored on the SoC (or in memory accessible to the SoC); instead, the task scheduling circuitry may be configured to determine or estimate these properties. For example, the PDN droop susceptibility may be estimated by the task scheduling circuitry, with the techniques such as regression models and machine learning optionally being used to refine the estimate.

The minor variations between the logically homogeneous processor cores can have a significant impact on the performance of the SoC 102 as a whole. For example, considering the thermal heat transfer properties, the processor cores towards the centre of the chip are more prone to overheating (as discussed above), due to the reduced ability to dissipate heat away from these cores. If these cores do overheat, it may be necessary for them to be placed in a low-power or powered-down state to allow them to cool, during which time they may not be able to execute tasks. This can lead to a reduction in the performance of the system overall, since fewer processor cores are likely to be available at any given time, thus reducing the number of tasks that can be executed concurrently. Another way in which these variations can affect the performance of the system is due to the variations in F_{MAX}. To execute a high performance task, a processor core typically operates at a high frequency. Therefore, the F_{MAX} value of a given processor core indicates the limit of its performance capabilities. Hence, if a task is scheduled to a processor core with and F_{MAX} value lower than the required/desired frequency for executing the task, the task will be executed with lower performance, which in turn can lower the overall performance of the system.

The variations between the processor cores can also affect the power consumption of the system. For example, power consumption can be reduced by executing some tasks—e.g. lower priority tasks, or those with a lower performance requirement—at a lower frequency. However, the V_{MIN} of a given processor core limits how much the frequency can be reduced by, since the frequency is dependent on the voltage.

Accordingly, the inventors of the present technique recognised the potential issues these physical circuit implementation dependent variations between logically homogeneous processor cores can cause, and developed an approach to reduce the impact of these issues on performance and energy efficiency.

FIG. 2 shows an example of task scheduling circuitry (scheduler) 202 configured to allocate tasks to the plurality of processor cores 104 shown in FIG. 1. The task scheduling circuitry 202 could be dedicated hardware (such as a system control processor (SCP)) or one of the processor cores on the SoC executing a task scheduling program (task scheduling code).

The task scheduling circuitry 202 allocates tasks to be executed by processor cores on the SoC. One approach to scheduling tasks could be to perform scheduling in absence of knowledge of the physical circuit implementation properties associated with the processor cores and then, having selected a core to allocate a task to, varying the operating frequency/voltage of the core or the duration for which the task can run before shutting down to prevent overheating, based on knowledge of silicon corners or other implementation properties. Indeed, since the processor cores are logically homogeneous, this might be the approach that a skilled person would expect to be taken. However, a disadvantage of this approach is that this may result in a given task being allocated to a particular core with, say, a relatively high minimum voltage supported, when that task could have executed more efficiently on a core with a lower minimum voltage, resulting in an opportunity to save power being lost. Similarly, a task could be allocated to a core prone to overheating sooner due to its worse heat dissipation properties, when another core was available which had better heat dissipation properties and so could execute the task at a given level of performance for longer without overheating, leading to overheating-prevention mechanisms halting the task sooner than was really necessary and hence sacrificing some performance. Hence, scheduling the tasks without considering the physical circuit implementation properties, and only considering the physical circuit implementation properties of a particular core once the task has already been allocated to that core, will tend to result in opportunities to save power or improve performance being lost.

The inventors of the present technique realised that significant improvements in performance and/or energy efficiency could be achieved by instead taking into account the physical circuit implementation properties at the time of selecting a processor core to allocate a task to, rather than scheduling tasks independently of these properties, and then adjusting the parameters of the selected core afterwards. For this reason, the processor core selected for a particular task by the task scheduling circuitry 202 of FIG. 2 is determined based on a least one physical circuit implementation property (e.g. this could be one of the properties shown in the table 112 shown in FIG. 1) associated with at least a subset of the cores.

For example, FIG. 2 shows a process in which (1) the next task in a job queue 204 is identified by the task scheduling circuitry 202. The form of the job queue 204 is not particularly limited—for example, it could be any type of buffer, such as a first-in-first-out (FIFO) buffer, storing job identifiers (JobIDs) of pending tasks.

The scheduling circuitry 202 then (2) looks up at least one physical circuit implementation property 206 held in memory or local storage for at least a subset of the processor cores on the SoC. For example, the scheduling circuitry 202 may look up, for at least a subset of the processor cores (e.g. a subset could be all of the cores, or it could be a proper subset of the cores) for which parameter tables are stored, a parameter table identifying properties such as those shown in the table 112 of FIG. 1. For example, the scheduling circuitry may look up the parameter tables for all of the cores for which parameter tables are stored, or just some (e.g. a proper subset) of the cores for which parameter tables are stored (e.g. only those cores which are available to execute a task). In other examples, the task scheduling circuitry may select a given core based on, for example, the availability of each core, and look up a parameter table for just that core.

In any case, based on at least one physical circuit implementation property defined in the parameter table(s), the scheduling circuitry 202 can then (3) select an available processor core 208 for the task to be allocated to. For example, when the parameter for just the given core was looked up, this could involve determining whether to allocate the task to the given core (e.g. whether the given core is to be the selected core for executing the task); when it is determined not to allocate the task to the given core (e.g. it is determined that the given core is not suitable) another core may be selected and another lookup of the parameter tables may be performed in respect of that core.

Once a processor core has been selected, the task scheduler allocates (4) the task to be executed by the processing circuitry 210 on the selected processor core 208.

Incidentally, although this example shows the present technique being used to allocate pending tasks from a job queue 204, for which for which execution has not yet begun, it should be appreciated that this is not the only use for the present technique. For example, this technique can also be applied to tasks which are already being executed. The scheduling circuitry 202 may apply the present technique to determine whether another processor core is available that is a better choice for executing a given task which has already begun execution on one of the processor cores.

Turning now to FIG. 3, this figure is a flow diagram illustrating an example of a method which may be applied by the scheduling circuitry 202, without requiring the use of parameter tables. In this example, the scheduling circuitry is responsive to a task to be scheduled to determine S302 whether at least one performance requirement of the task is greater than a predetermined threshold. For example, the performance requirement of the task may be indicated as a lower limit of frequency at which the task is to be executed, or could be a simply indication of whether or not the task is a high priority task (e.g. with high priority tasks being considered to have a performance requirement above the threshold).

When the performance requirement of the task is greater than the threshold (Y), the scheduling circuitry 202 is configured to allocate S304 the task to a processor core in an outer region of the SoC (e.g. a processor core at or close to the edge of the SoC). On the other hand, if the performance requirement of the task is not greater than the threshold (e.g. if it is less than or equal to the threshold), then the scheduling circuitry is configured to allocate S306 the task to a processor core in a central region of the SoC.

By this approach, tasks which are likely to lead to the generation of a larger amount of heat—e.g. due to their higher performance requirements, which may require the allocated processor core to operate at a higher frequency, thus generating more heat—are scheduled to an area of the chip (an outside region) where the ability to dissipate heat is greater. This reduces the temperature gradient across the chip (e.g. reduces the amount of heat generated at the centre of the chip, so that the temperature at the centre of the chip does not raise as high), reducing the likelihood of processor cores at the centre of the chip being put into a low/no power state, and thus allowing for an improvement in performance (since a greater proportion of the processor cores remain available).

The method of FIG. 3 is a particularly easy-to-implement way of applying the present technique, since it does not require parameter tables to be stored for each processor core. Nonetheless, as shown in FIG. 4, this approach can still be effective at reducing the temperature gradient between the centre of the chip and the outside the chip, thus leading to an improved performance, as discussed above.

In particular, FIG. 4 shows the same SoC 102 as in FIG. 1. However, in this example, tasks requiring the highest level of performance have been allocated to processor cores 104a in an outside region of the SoC (in this case, the processor cores closest to the edge of the SoC), and tasks with the lowest performance requirements have been scheduled to processor cores 104b in an inner region of the SoC (in this case, the processor cores furthest from the edge/nearest to the centre of the SoC). As a result, the temperature gradient between the centre of the chip and the edges of the chip is significantly reduced.

In the example of FIG. 4, three regions are shown: an outside region comprising the processor cores 104a closest to the edge of the chip; an inner region comprising the processor cores 104b closest to the centre of the chip; and a middle region comprising the remaining processor cores 104c. However, it will be appreciated that this is just one example of how the processor cores 104 may be grouped into “regions”. Any definition of the outer region—to which high-performance/high priority tasks are scheduled—and the inner region—to which low-performance/low priority tasks are scheduled—can be used, provided that at least some of the processor cores 104a in the outer region are closer to the edge of the chip 102 than the processor cores 104b in the inner region. The outer region and the inner region may, in some examples, overlap (e.g. some processor cores may be considered to be in both regions).

In the example discussed above, with reference to FIG. 4, tasks are scheduled based on a performance requirement of the task and a position of each processor core relative to the edge of the SoC. However, this is just one example of how the technique of the present technique might be implemented. The method of FIG. 5 shows another example of a method of scheduling tasks which uses parameter tables stored in memory or local storage.

The method of FIG. 5 is performed by the task scheduling circuitry in response to a task needing to be scheduled (e.g. allocated to a processor core). In particular, in response to a task to be scheduled (e.g. in response to the task scheduling circuitry receiving the next job ID in a job queue, or the job ID of a task that is already being executed), the parameter tables are looked up S502 for available cores which meet the performance requirements of the task. This is an example of obtaining at least one physical circuit implementation property associated with a given processor core, and may involve looking up the parameter tables of all processor cores which are available and meet the performance requirements of the task, or it may involve looking up the parameter tables for just a subset of these processor cores.

The parameter tables are used to select S504 an available processor core. For example, this may involve comparing at least one physical circuit implementation property, defined in the parameter tables, for each available core (or each core in the subset of cores for which the parameter tables were looked up), and selecting an available core based on the comparison. This is an example of selecting, based on the at least one physical circuit implementation property, whether the given task is allocated to the given processor core.

Once a core has been chosen, the task is allocated S506 to that core. Hence, using this technique, any number of physical circuit implementation properties can be used to select a processor core to allocate the task to, which can lead to an improvement in the performance and/or energy efficiency of the SoC as discussed above.

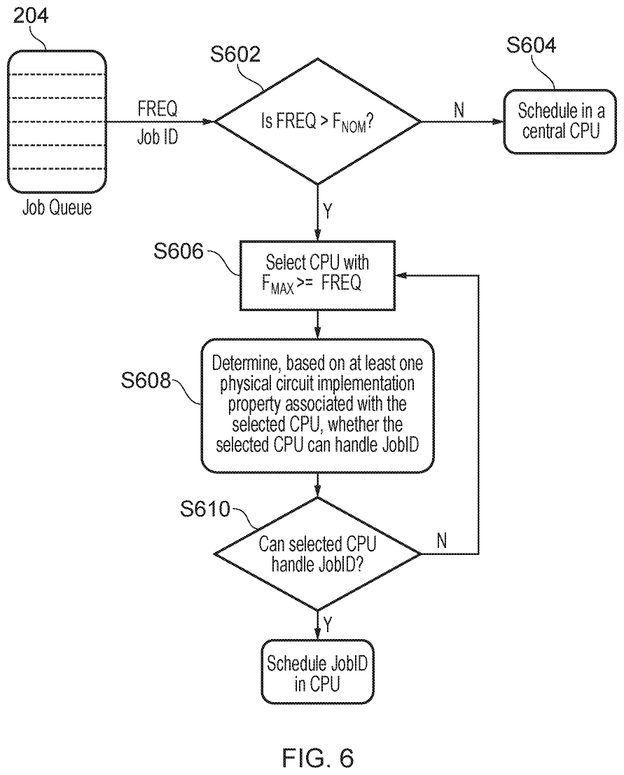

FIG. 6 is a flow diagram showing another example method for allocating a given task to a processor core in the SoC. The method of FIG. 6 is performed by the task scheduling circuitry, and may be an example of the method shown in FIG. 5 (e.g. if parameter tables are used).

As shown in FIG. 6, a given task is selected from the job queue 204, and its Job ID and required frequency (FREQ) are provided to the task scheduling circuitry. The method then involves checking S602 whether FREQ is greater than some predetermined threshold frequency (F_{NOM}). Similarly to the method described in FIG. 3, if FREQ is less than or equal to F_{NOM}, the task is scheduled S604 to a central processor core. Accordingly, this allows the lowest performance tasks to be scheduled to central processor cores, which can then be allowed to operate at a lower frequency, such that they generate less heat. However, it should be appreciated that steps S602 and S604 can, optionally, be omitted from this method.

The method also involves selecting S606 a given processor core with an upper limit of frequency (F_{MAX}) greater than or equal to (e.g. not less than) FREQ. For the given processor core, it is determined S608, S610—based on at least one physical circuit implementation property associated with the given core—whether the given core can handle the given task. For example, this could involve determining whether the given core is likely to overheat if it executed the given task, or whether it is likely to be able to maintain the required performance level for the duration of the task, e.g. given the position of the core on the SoC and/or the heat transfer characteristics of the core.

When it is determined the given processor core (e.g. the selected CPU) can handle the given task, the task is allocated S612 to be executed by processing circuitry of that processor core. On the other hand, when it is determined that the given processor core cannot handle the given task, another processor core with F_{MAX}>=FREQ is selected S606, and the process repeats until a suitable processor core is found.

As shown in the table 112 of FIG. 1, an example of a physical circuit implementation property associated with a given processor core is its susceptibility to a voltage droop associated with the power delivery network (e.g. its droop characteristic), which could indicate whether the given processor core is more susceptible to resistive (IR—current multiplied by resistance) droops, or reactive droops (e.g. inductive droops, based on L*di/dt—inductance multiplied by the rate of chance of current).

A particular processor core may be more susceptible to one type of voltage droop than others, and a given task may be more susceptible to one type of voltage droop than others. It can, therefore, be useful to consider the voltage droop characteristics (e.g. an indication of which type of voltage droop the core/task is more susceptible to) of the given core and the given task.

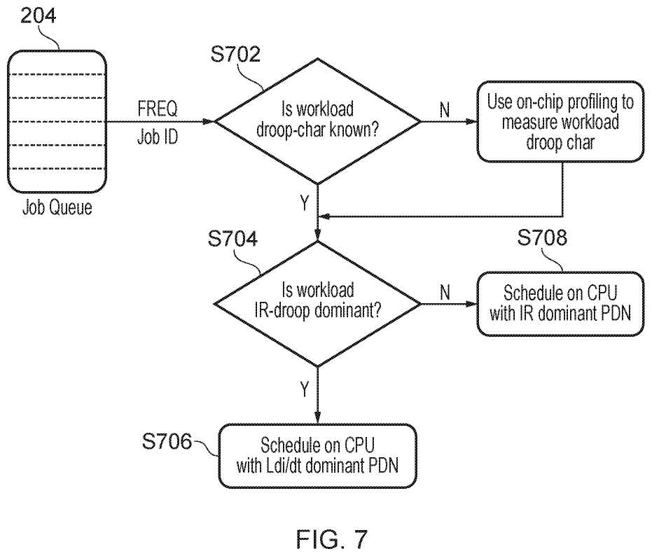

An example of a method for selecting a processor core based on the droop characteristic of the given task is shown in FIG. 7. In FIG. 7, a task is selected from the job queue 204, and it is determined S702 whether the droop characteristic of the workload (task) is known. When the workload droop characteristic is known (Y), it is determined S704 whether the workload is more susceptible to IR voltage droops (e.g. it is IR-droop dominant).

When the workload is IR-droop dominant (Y), it is allocated S706 to a processor core which is di/dt-droop dominant, and when the workload is di/dt-droop dominant (N), it is allocated S708 to a processor core which is IR-droop dominant. In this way, the effect of voltage droop on the performance of a given processor core can be reduced.

Returning to step S702, when the workload droop characteristic for the given task is not known (N), on-chip profiling is used S710 to measure the workload droop characteristic, before proceeding to step S704. For example, on-chip profiling could involve determining an initial estimate of the droop characteristic, and refining this estimate using linear regression models or machine learning. However, it should be appreciated that any other form of on-chip profiling could be used instead.

As can be seen from the above discussion, it is possible to achieve significant improvements in performance and/or energy efficiency by considering one or more physical circuit implementation properties associated with the processor cores on a system on chip, even when all of the processor cores are logically homogeneous. There are many different types of physical circuit implementation property which can be considered, and there are different ways that these properties can be considered, as can be seen from the discussion above, and any one of these approaches may be applied. Moreover, it is possible to combine any of the approaches above—for example, one could perform the method of FIG. 3 or FIG. 6 in combination with the method of FIG. 7—and achieve the same (if not, in some cases, greater) improvements in performance and energy efficiency.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. A system on chip comprising:
a plurality of logically homogeneous processor cores, each processor core comprising processing circuitry to execute tasks allocated to that processor core; and
task scheduling circuitry configured to allocate tasks to the plurality of processor cores,
wherein the task scheduling circuitry is configured, for a given task to be allocated, to determine, based on at least one physical circuit implementation property associated with a given processor core, whether the given task is allocated to the given processor core.

2. The system on chip of claim 1, wherein the at least one physical circuit implementation property is indicative of at least one of:
an ability to dissipate heat away from the given processor core; and a duration that a given performance level can be maintained on the given processor core.

3. The system on chip of claim 1, wherein the at least one physical circuit implementation property comprises at least one of:
a position of the given processor core within the system on chip;
a thermal heat transfer parameter associated with the given processor core;
an upper limit of frequency at which the given processor core can operate;
a lower limit of voltage at which the given processor core can operate;
a susceptibility of the given processor core to voltage droops; and
a susceptibility of the given processor core to aging.

4. The system on chip of claim 1, wherein
the task scheduling circuitry is configured to determine whether the given task is allocated to the given processor core in dependence on at least one performance requirement associated with the given task.

5. The system on chip of claim 4, wherein:
the at least one physical circuit implementation property comprises a position of the given processor within the system on chip; and
when the at least one performance requirement exceeds a threshold performance requirement, the task scheduling circuitry is configured to allocate the given task to a processor core in an outer region of the system on chip.

6. The system on chip of claim 4, wherein:
the at least one physical circuit implementation property comprises a lower limit of voltage at which the given processor core can operate; and
when the at least one performance requirement is less than a threshold performance requirement, the task scheduling circuitry is configured to allocate the given task to a processor core with a lower limit of voltage below a predetermined value.

7. The system on chip of claim 1, wherein
the at least one physical circuit implementation property comprises a position, relative to a power distribution network of the system on chip, of the given processor core within the system on chip.

8. The system on chip of claim 1, wherein:
the at least one physical circuit implementation property comprises an upper limit of frequency at which the given processor core can operate;
the given task is associated with a given frequency indicative of a performance requirement of the given task; and
the task scheduling circuitry is configured to determine whether the given task is allocated to the given processor core in dependence on the given frequency.

9. The system on chip of claim 8, wherein
the task scheduling circuitry is configured to allocate the given task to a processor core for which the upper limit of frequency is equal to or greater than the given frequency.

10. The system on chip of claim 1, wherein:
the at least one physical circuit implementation property comprises a susceptibility of the given processor core to voltage droops; and
the task scheduling circuitry is configured to determine whether the given task is allocated to the given processor core in dependence on a droop characteristic associated with the given task.

11. The system on chip of claim 10, wherein:
the susceptibility of each processor core to voltage droops comprises an indication of whether each processor core is more susceptible to a resistive voltage droop or a reactive voltage droop; and
the droop characteristic of the given task is indicative of whether the given task is more susceptible to the resistive voltage droop or the reactive voltage droop.

12. The system on chip of claim 11, wherein:
when the droop characteristic of the given task indicates that the given task is more susceptible to the resistive voltage droop, the task scheduling circuitry is configured to allocate the given task to a processor core which is less susceptible to the resistive voltage droop; and
when the droop characteristic of the given task indicates that the given task is more susceptible to the reactive voltage droop, the task scheduling circuitry is configured to allocate the given task to a processor core which is less susceptible to the reactive voltage droop.

13. The system on chip of claim 10, wherein
when the droop characteristic of the given task is unknown, the task scheduling circuitry is configured to perform on-chip profiling of the given task to determine an estimate of the droop characteristic.

14. The system on chip of claim 1, wherein, in at least one mode:
the given task comprises a task already being executed by the given processor core;
the task scheduling circuitry is configured to determine, based on the at least one physical circuit implementation property, whether a different processor core is a better choice for the given task than the given processor core; and
the task scheduling circuitry is responsive to determining that the different processor core for is a better choice for the given task to re-allocate the given task from the given processor core to the different processor core.

15. The system on chip of claim 14, wherein
the at least one physical implementation property comprises a thermal property associated with the given core.

16. The system on chip of claim 1, wherein
the task scheduling circuitry is configured to select, as the given processor core, an available processor core which meets at least one performance requirement associated with the given task.

17. The system on chip of claim 1, wherein each of the plurality of logically homogeneous processor cores has at least one of:
the same microarchitectural arrangement; and
the same logical transistor arrangement.

18. The system on chip of claim 1, wherein the task scheduling circuitry comprises one of:
a dedicated task scheduling processor core; and
one of the plurality of logically homogeneous processor cores executing a task scheduling process.

19. A method of allocating tasks to a plurality of processor cores, the plurality of processor cores comprising a plurality of logically homogeneous processor cores within a system on chip, each processor core comprising processing circuitry to execute tasks allocated to that processor core, and the method comprising, for a given task:
obtaining at least one physical circuit implementation property associated with a given processor core; and
selecting, based on the at least one physical circuit implementation property, whether the given task is allocated to the given processor core.

20. A computer program for controlling a computer to perform the method of claim 19.
